(19) United States
(12) Patent Application Publication
(10) Pub. No.: US 2010/0062144 A1
(43) Pub. Date: Mar. 11, 2010

(54) Document security, securities and article protection method using nanodiamonds with active NV centers

(75) Inventors: Sergey A. Zibrov, Troitsk Moscovskaya obl. (RU); Vitaly V. Vasilyev, Troitsk Moscovskaya obl, (RU); Vladimir L. Velichansky, Moscow (RU); Vyacheslav G. Pevgov, Odintsovo (RU); Viktor M. Rudoi, Moscow (RU)

Correspondence Address: HOUSTON ELISEEVA, 4 MILITIA DRIVE, SUITE 4, LEXINGTON, MA, 02421, US

(73) Assignee: OOO "NOVYE ENERGETICHESKIE TEKHNOLOGII", Moscow (RU)

(21) Appl. No.: 12/487,350

(22) Filed: Jun. 18, 2009

(30) Foreign Application Priority Data
Sep. 10, 2008 (RU) 2008136466

(51) Int. Cl. B44F 1/12

(52) U.S. Cl. 427/7; 977/773

(57) ABSTRACT

The invention relates to the field of the protection of securities, documents, and articles. A method of protection of documents, securities, or articles using quantum markers based on active nitrogen vacancy centers in nanocrystals of diamonds is proposed in the invention. The technical result is an increase in the reliability of the protection of the object of protection against falsification. The technical result is achieved by the fact that, in a method of protection of documents, securities, and articles that consists in the fact that the optical properties of NV centers of nanoparticles of diamond are used for protection against counterfeits, during the fabrication of the object of protection, nanoparticles of diamond measuring from 5 to 150 nm are introduced into it or into its constituent components. 1 dependent claim, 2 illustrations.

### RELATED APPLICATIONS

This application claims priority to Russian Patent Application No. 2008136466, filed on Sep. 10, 2008, which is incorporated herein by reference in its entirety.

### FIELD OF THE INVENTION

The invention relates to the field of the protection of securities and documents. The introduction of a new marker using nanocrystals of diamonds with active nitrogen vacancy (NV) centers is proposed in the invention. The presence of the marker in a document is probed by radiation in the optical range or by the combined action of electromagnetic radiation in the optical and SHF range.

### BACKGROUND OF THE INVENTION

A search has been conducted recently for means of performing quantum computations. To achieve this objective a physical object is required in which, first, the creation of relatively long-lived superpositional states that are the quantum information carrier—the qubit—is possible; and second, the transfer of this state to a photon and back is possible. In principle, a qubit can be stored in any two-level quantum system. However, none of the set of objects tested—spin states of atoms, quantum points, superconducting circuits, ions in traps—possesses sufficient simplicity and reliability for practical applications. The reasons are varied: in some cases this is associated with short longitudinal and transverse relaxation times; in others, with the low stability of the systems examined, or with the difficulty of controlling their state. Only with the discovery of active NV centers [F. Jelezko, J. Wrachtrup, Single defect centres in diamond: A review, Phys. Stat. Sol. (a) 203, No. 13, 3207-3225 (2006), Doc. 1] in diamond crystals has a practically significant alternative to the implementation of qubits appeared. In the ground state of these centers the creation of coherent superpositions of quantum states is possible, and the permitted optical dipole transition makes it possible to poll these states by photons. The potential for the use of NV centers in diamond nanocrystals as unique markers for purposes of the protection of objects is determined by the combination of their specific quantum properties (interference of wave functions of various states) with photostability at room temperature and high durability of the matrix.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 is a representation of the spatial structure of the named center; and

FIG. 2 is a representation of the energy levels of the NV center.

### DETAILED DESCRIPTION OF THE PREFERRED EMBODIMENTS

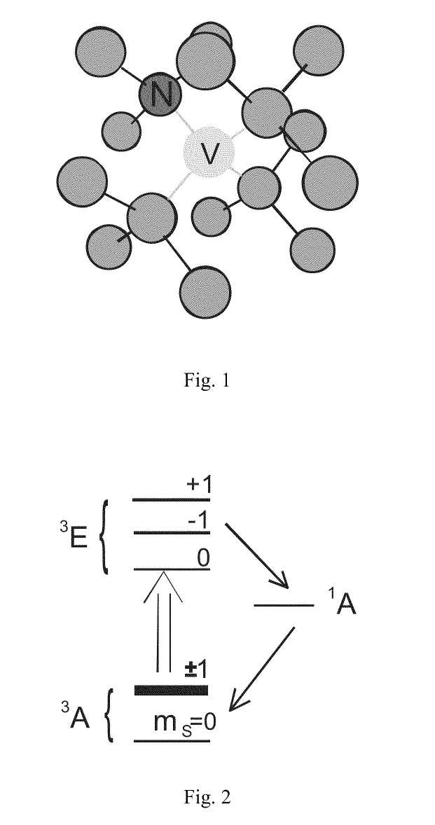

The NV center is a defect of the diamond lattice, from which two neighboring carbon atoms are removed, and a nitrogen atom introduced in the place of one. The negatively charged NV center, in which the nitrogen atom and the neighboring vacancy capture an electron, forming a charged paramagnetic center, is considered in what follows. The spatial structure of the named center is represented in FIG. 1. The energy levels of the NV center that are responsible for the above-enumerated properties are shown (not to scale) in FIG. 2. The NV center has C3v group symmetry. The NV center's electron states and the energy levels corresponding to them are identified according to the representations of this group. The ³A ground state has a nongenerated fine structure of levels in which the projection of the spin on the symmetry axis has the value 0 or ±1. Based on measurements of the constants of the fine and hyperfine splittings of the ground level, it was concluded that 70% of the spin density of the electrons is distributed over the three carbon atoms bonded with the nitrogen, and the region of the vacancy practically completely accounts for the remaining 30% (only about 2% of the total spin density is concentrated at the nitrogen atom). The principal isotope of carbon has zero nuclear spin. Therefore, magnetic interactions of the ground state of the NV center with neighboring nuclei of the lattice that are caused by nuclear spin are absent. This results in the long coherence lifetime of the paramagnetic center in the ground state.

The permitted transition between the ground state and the ³E level has a total oscillator strength of 0.2. The wavelength of the phononless transition for these levels is 637 nm. This optical transition makes it possible to control the long-lived spin state of the ground state of the NV center and to read it. Such an interaction is successfully accomplished even for a single isolated NV center [Doc. 1]. The relaxation of the ³E level occurs via two channels: radiatively with transition to the ground state, and nonradiatively through an intermediate metastable ¹A level. The presence of the nonradiative channel, on the one hand, decreases fluorescence; on the other hand, it leads to unbalanced distribution of the populations of the sublevels of the ground state and makes the observation of double radiooptic resonance possible. Double resonance results in total fluorescent power at the optical transition varying during exposure of a marker with NV centers to a narrow-band SHF signal.

We use diamond nanocrystals measuring 5-150 nm with NV centers created in them for the formation of markers. The small size of the crystals makes them invisible under the optical microscope and suppresses the effect of full internal reflection; this increases the fluorescence efficiency and decreases the amount of material required in the marker.

The choice of the range of permissible dimensions of the nanocrystals is associated, on the one hand, with the necessity of isolating the active center of the diamond lattice from the surrounding medium, and on the other, with the desire to increase the output of radiation from the diamond crystal, which is reduced in the case of larger crystals due to the effect of full internal reflection.

A method is known (US2003173046 A1, 18 Sep. 2003, Doc. 2) in which micro- or nanostructures based on diffractive optical elements, with a special structure that is manifested only with the use of special means of control and is expressed in a diffraction pattern obtained through illumination by coherent radiation, are proposed as means of protection of documents and securities.

A patent (RU23 12882 C2, 20 Dec. 2007, Doc. 3), which is taken as a prototype, is closest to our proposal. Its authors proposed to use printing fluid with nanoparticles of salts and oxides of metals in the form of crystalline solid particles, with a mean diameter less than 300 nm, fluorescing or phosphorescing upon excitation, introduced into it. A large number of substances that may be used as luminophor additives in the composition of said nanoparticles are proposed in the named patent.

Luminophors in which luminescence is determined solely by the populations of energy levels and the total radiation from many statistically independent centers are considered in the prototype. We, on the other hand, are proposing to use not solely the excitation of unbalanced populations of the NV centers in diamond nanocrystals, but the long-lived coherent superpositions of the wave functions of the sublevels of their ground state as well.

At the present time, diamonds with active NV centers are obtained by their exposure to an electron or ion beam with subsequent annealing at high temperature. It may be expected that simpler methods for synthesizing them will appear in the near future.

Diamond is a promising candidate for the search for other active optical centers as well, since as a result of the high rigidity of its lattice it has a low density of phonon states, and for that reason, less efficiency of the interaction of localized quantum states with phonons.

Summarizing the aforesaid, it can be said that the proposed invention is distinguished by the fact that nanoparticles of diamond with NV centers specially created in them may be used for the protection of documents, securities, and other articles by means of the introduction of such nanoparticles into lacquers, dyes, glues, fibers, and other materials used for the fabrication of the articles to be protected. At the same time, the unique properties of the NV centers mentioned above make it possible to use for their registration both traditional spectroscopic methods and the coherent effects of the interaction of radiation with the substance.

Checking the authenticity of the object of protection is carried out by optical methods that presume the presence of a source of optical excitation with a wavelength in the 500-550 nm range, for example, by second-harmonic radiation of an yttrium-aluminum garnet laser (532 nm). A photoreceiver device tuned to wavelengths in the 630-800 nm range analyzes the spectral and temporal characteristics of the luminescence signal received.

A conclusion on the presence of the protective marker is made on the basis of:

1) the expected spectral characteristics of the fluorescence (traditional method);

2) the relationship of the steady-state fluorescence signal to the frequency interval between the two components of the bichromatic optical field; either two longitudinal modes of the probing laser, or modulation of single-frequency monochromatic radiation at a frequency equal to half the fine interval of the ground state of the NV center Δνₛₜ (or 0.25 of Δνₛₜ, if the frequency is subsequently doubled), are used for the formation of this bichromatic optical field; when the frequency interval between the two lateral components of the probing laser is equal to Δνₛₜ, nonabsorbing superposition of the TM states of the center occurs, and absorption declines (along with the fluorescence signal); this effect is called coherent population trapping and is widely used in spectroscopy and metrology; the great life-time of coherence in the ground state of the NV center is the condition for the observation of this effect;

3) the difference in the fluorescence signal, with simultaneous excitation by a resonance SHF field and without it; this difference occurs for the following reason: the absorption of the probe radiation takes place all at once from all the sublevels of the ground state of the NV center; in the case of nonradiative relaxation, redistribution of the populations takes place due to selectivity of the channels of relaxation according to the magnetic projection of the moment of the center, and the redistribution becomes unbalanced; inclusion of the SHF field of resonance splitting of the ground state alters the distribution, bringing it closer to balanced; as a result, the absorption of the laser radiation varies together with the fluorescence signal being registered.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method of protection of documents, securities, and articles by means of nanocrystals of diamond with an active NV center, consisting in the fact that a marker that fluoresces under the influence of external radiation is introduced into or applied to the document, security, or article to be protected, distinguished by the fact that the marker is a nanocrystal of diamond with an active NV center.

2. A method according to claim 1 in which a nanocrystal of diamond with an active NV center measuring from 5 to 150 nm is used.
